(19) United States
(12) Patent Application Publication
(10) Pub. No.: US 2025/0297901 A1
(43) Pub. Date: Sep. 25, 2025

(54) Optical Signal Transfer Mechanism For A Vacuum Compatible Spring Loaded Thermometry Probe

(71) Applicant: Advanced Energy Industries, Inc., Denver, CO (US)

(72) Inventors: Sebastian James Haube, Santa Clara, CA (US); Terry Stapleton, San Jose, CA (US); Jason Errett, Scotts Valley, CA (US); Tim P. Dubbs, Santa Cruz, CA (US); Chung-Chieh Cheng, Denver, CO (US)

(21) Appl. No.: 18/611,945

(22) Filed: Mar. 21, 2024

(51) Int. Cl. G01K 11/32

(52) U.S. Cl. CPC G01K 11/32

(57) ABSTRACT

A fiber optic temperature probe is disclosed. The fiber optic temperature probe includes a probe shaft containing an optical fiber. An optical temperature sensor element is coupled to the probe shaft and configured to be excited by light from the optical fiber and emit light back to the optical fiber.

### BACKGROUND

### Field

The present disclosed embodiments relate generally to temperature sensing devices, and more specifically to optical temperature sensing devices.

### Background

Fiber optic temperature sensors hold a number of unique advantages over other temperature measuring devices, particularly when operating in the presence of strong electromagnetic fields or when measuring very low temperatures, such as down to −100° C. More specifically, fiber optic temperature sensors are well suited to measuring temperatures of plasma processing chamber components; however, the harsh environment within plasma processing chambers often limits the viability of such fiber optic temperature sensors.

The in-chamber operation of many current fiber optic temperature sensors is infeasible due to the harsh environment within most plasma processing chambers. Specifically, any components of a fiber optic temperature sensor within a plasma processing chamber must be chemically resistant to the harsh environment within the plasma processing chamber and chemically compatible with the process taking place within the plasma processing chamber to maintain functionality while avoiding process contamination. For example, many current fiber optic temperature sensors fabricated using silicone, epoxy, or inorganic ceramic adhesives, which may contain known ionic contaminants (e.g., sodium, potassium, etc.), may degrade upon exposure to the plasma processing chamber environment or contaminate the process.

There is also a need for compact probes to fit within tight spaces. Generally, spring loaded fiber optic temperature probes are used for applications requiring compact probes. Typical spring loaded fiber optic temperature probes utilize a single fiber strand along the entire length of the probe allowing for a seamless spring-loaded action without interruption of signal. Specifically, in low temperature vacuum applications with tight space constraints and low cost requirements, a flexible plastic optical fiber could be used to form an internal loop. However, where temperatures exceed 100° C., a plastic optical fiber is not practical because of the temperature sensitivities. While silica fibers can be used, they do not have bend radii suitable for a compact probe. Furthermore, any bundled silica fiber would reduce the signal quality from the probe tip (for example, from the phosphor or fluorescent).

There is therefore a need in the art for a new optical temperature sensor design that addresses some of the current shortcomings, particularly those requiring compact probes in high temperature and/or other harsh environments.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In some embodiments, a fiber optic temperature probe is provided comprising: a first fiber coupled to a connector assembly; a second fiber coupled to the connector assembly, wherein the connector assembly includes a first optical element to collimate light from the first fiber and a second optical element to decollimate light into a first end of a second fiber; and a temperature sensor coupled to a second end of the second fiber. In some embodiments, the first optical element and the second optical element are located within a spring-loaded vacuum. In various embodiments, the first fiber is coupled to a converter unit prior to coupling the first fiber to the connector assembly. In many embodiments, the first fiber and the second fiber comprise silica. In various embodiments, each of the first optical element and second optical element can comprise, for example, refractive or reflective optical devices such as lenses, ball lenses, lens arrays, mirrors and mirror arrays with various surface profiles such as spherical, aspherical, diffractive and meta-surfaces or others. The underlying optical material may be gradient index (GRIN) materials, meta-material, or others. The embodiment 110 shown in FIG. 1 is a ball lens. In many embodiments, the temperature sensor is coupled to a probe shaft surrounding the second fiber, and it may comprise one of a phosphorescent or a fluorescent material. In some embodiments, the fiber optic temperature probe also comprises a thermally conductive plate coupled to a tip of the probe shaft and configured to be thermally exposed to an exterior environment in one direction, where a surface of the thermally conductive plate not exposed to the exterior environment is configured to thermally interface with the temperature sensor.

In other embodiments, a fiber optic temperature probe comprising: a first fiber coupled to a connector assembly; a second fiber coupled to the connector assembly, wherein the connector assembly includes a first ball lens to collimate light from the first fiber and a second ball lens to decollimate light into a first end of a second fiber; and a temperature sensor coupled to a probe shaft surrounding the second fiber is provided. In many embodiments, the ball lenses are located within a spring-loaded vacuum. In some embodiments, the first fiber is coupled to a converter unit prior to coupling the first fiber to the connector assembly, and the first fiber and the second fiber comprise silica. In various embodiments, the temperature sensor comprises one of a phosphorescent or a fluorescent material. In some embodiments, the probe further comprises a thermally conductive plate coupled to a tip of the probe shaft and configured to be thermally exposed to an exterior environment in one direction, where a surface of the thermally conductive plate not exposed to the exterior environment is configured to thermally interface with the temperature sensor.

In other embodiments still, a method of measuring the temperature of an element is provided that comprises: coupling a first end of a first fiber to a connector assembly; coupling a first end of a second fiber to a connector assembly; collimating a light from the first fiber using a first optical element; decollimating the light from the first fiber using a second optical element; and coupling the light from the first fiber into the second fiber using the second optical element. In some embodiments, the method further comprises coupling a second end of the first fiber to a converter unit and collimating the light from the first fiber using the first optical element and decollimating the light from the first fiber using the second optical element occur in a vacuum. In some embodiments, coupling the first end of the first fiber to the connector assembly comprises coupling a first silica fiber to the connector assembly, and wherein coupling the first end of the second fiber to the connector assembly comprises coupling a second silica fiber to the connector assembly. In various embodiments the method further comprises coupling a temperature sensor to a second end of the second fiber.

### BRIEF DESCRIPTION OF THE DRAWINGS

FIG. 1 illustrates a cross-sectional view of an exemplary embodiment of a fiber optic temperature probe;

FIG. 2 illustrates a cross-sectional view of an exemplary embodiment of a fiber optic temperature probe in a compressed state;

FIG. 3 illustrates a cross-sectional view of an exemplary internal view of a fiber coupling to an optical element in accordance with an embodiment; and

FIG. 4 illustrates a cross-sectional view of an exemplary exploded view of the internal and external elements of a connector assembly and optical components in accordance with an embodiment.

FIG. 5 illustrates an embodiment of collimating and decollimating light in accordance with an embodiment;

FIG. 6 illustrates an exemplary method of collimating light in a temperature probe in accordance with an embodiment; and

FIG. 7 illustrates a perspective view of an exemplary embodiment of a fiber optic temperature probe.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

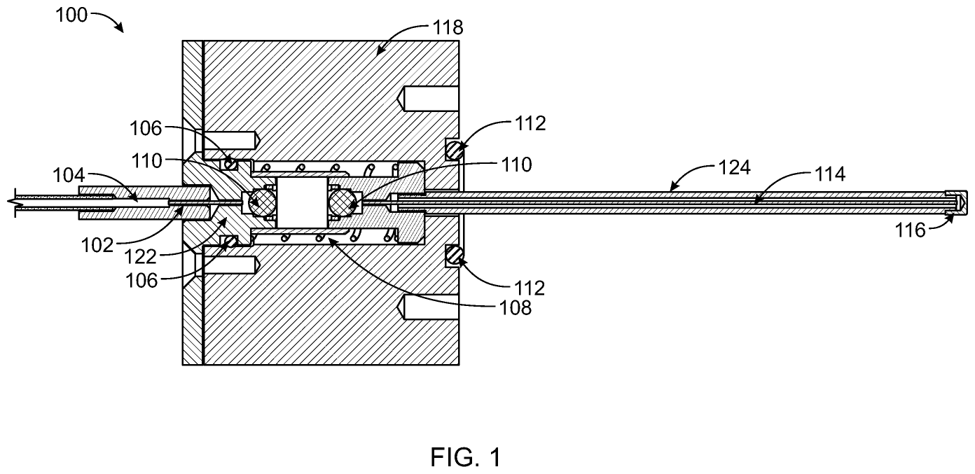

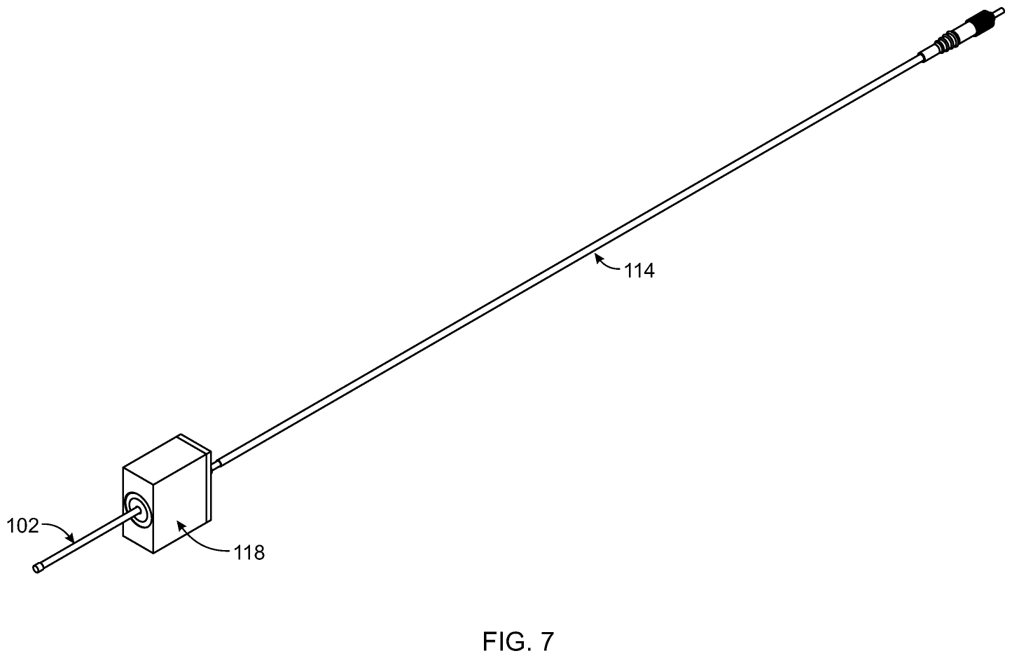

Some embodiments of the present disclosure, and with reference to FIG. 1 and FIG. 7, may comprise a fiber optic temperature probe 100 configured to take temperature measurements of a test article surface. In some embodiments, the fiber optic temperature probe 100 includes a connector assembly 118 coupled between at least one first fiber 102 and a second fiber 114. The second fiber 114 has a probe shaft 124 and an optical temperature sensing mechanism 116 coupled to the probe shaft 124 and optical fiber 114. Possible optical temperature sensing mechanisms may include, for example, phosphorescent or fluorescent thermal sensors, which may be excited with a pulse of light via the optical fiber.

In some embodiments, the connector assembly 118 comprises two optical elements 110 to facilitate transferring a signal between the first and second fibers 102, 114. For example, in some embodiments, optical elements 110 are used to collimate an optical signal or beam from first fiber 102 to second fiber 114. Each optical element 110 is mounted relative to the ends of one of the fibers 102, 114, such that a first optical element 110 is mounted relative to the end of fiber 102 entering the connector assembly 118 at a first side and a second optical element 110 is mounted relative to an end of fiber 114 entering the connector assembly 118 at a second side. In such embodiments, the light from the first fiber 102 is collimated through the first optical element 110 and that light is received by the second optical element 110 and focused into second fiber 114.

As used herein, each of first and second optical elements 110 can include, but are not limited to, a refractive or reflective optical devices such as lenses, ball lenses, lens arrays, mirrors, mirror arrays with various surface profiles such as spherical, aspherical, diffractive, and meta-surfaces a ball lens, a parabolic mirror, a collimating lens, a spherical mirror, a fiber lens, an aspherical lens, a spherical singlet, a spherical doublet, a cylindrical lens, a gradient index lens, and a micro lens array. In various embodiments, the underlying optical material of optical elements 110 may be Gradient Refractive Index (GRIN), meta-material, glass, crystals, silicon, germanium, zinc selenide, zinc sulfide, calcium fluoride, magnesium fluoride, optical plastics, diamond and the like. In many embodiments, the coefficient of thermal expansion of the optical elements 110 will be similar to that of the other elements of the connector assembly 118.

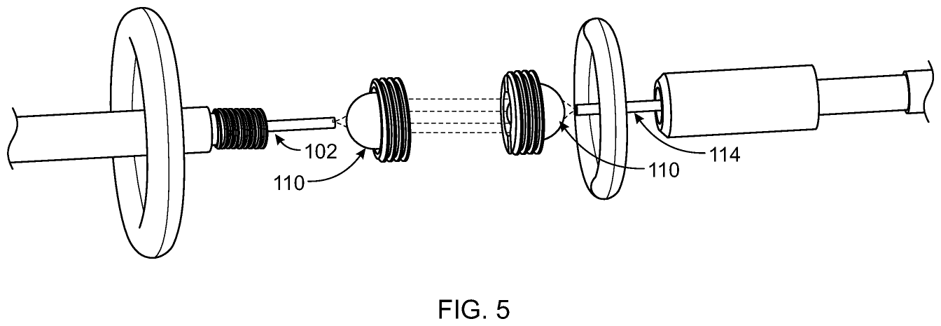

For example, with reference to an embodiment illustrated in FIG. 5, in some embodiments, a method of using a pair of spherical ball lenses to collimate a beam from a first fiber 102 to a second fiber 114 inside a spring-loaded vacuum probe 100 is provided. The first fiber 102 is coupled to a connector assembly 118 of a spring-loaded vacuum probe 100. In some embodiments, fiber 102 is coupled through a fiber optic converter unit prior to coupling with the connector assembly 118. The first ball lens 110 collimates the light source from the first fiber 102. The collimated light travels towards a second ball lens 110 that focuses the light, or decollimates the light, into second fiber 114.

In some embodiments, due to their spherical symmetry, ball lenses 110 exhibit minimal optical aberrations, such as spherical aberration and coma. In some embodiments, ball lenses 110 are very small, with diameters ranging from a fraction of a millimeter to a few millimeters. Their small size makes them suitable for integration into compact optical systems. In some embodiments, ball lenses 110 are made from materials with a high refractive index, such as glass or certain transparent crystals.

In some embodiments, the connector assembly 118 includes a spring 108 used to accommodate any force from the probe tip as it is coupled to an enclosure wall. For example, in some embodiments spring 108 allows up to 10 mm of lateral travel between the fibers 102, 114. In some embodiments, the spring 108 allows fibers 102, 114 up to 3 mm of vertical travel within the connector assembly 118.

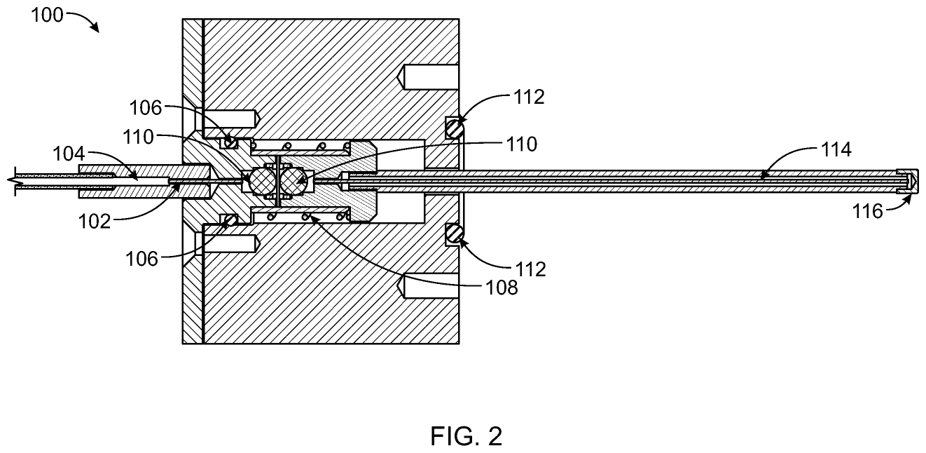

For example, with reference to embodiments illustrated in FIG. 1 and FIG. 2, the optical elements 110 within the connector assembly 118 may travel towards or away from each other based upon the compression or decompression of spring 108.

In some embodiments, the connector assembly 118 comprises a body made from a high-quality materials such as ceramic or a precision-engineered metal alloy known for its durability and low signal loss characteristics. In many embodiments, connector assembly 118 comprises a thermally insulating material.

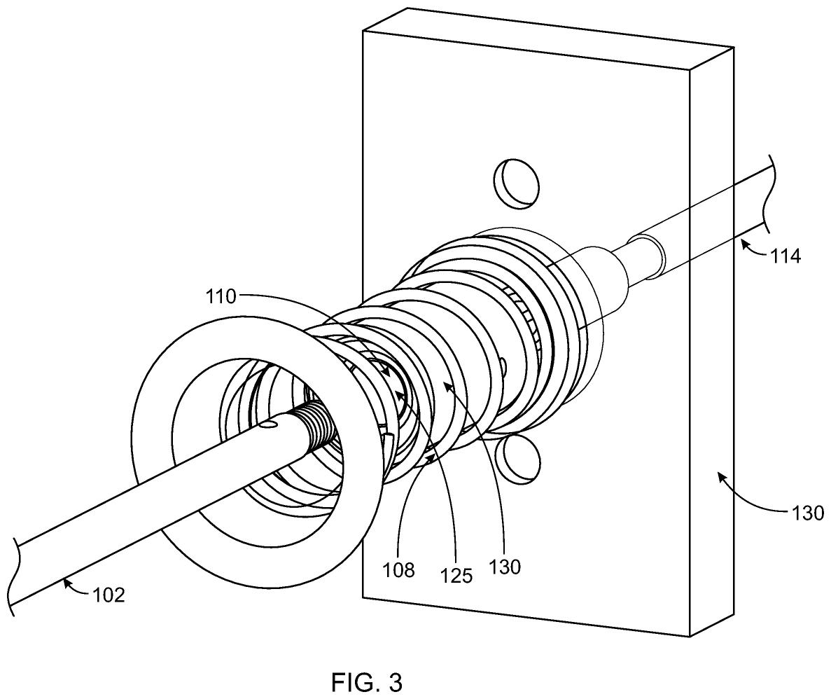

In some embodiments, and with reference to an embodiment illustrated in FIG. 3, optical elements 110 are mounted within connector assembly 118 by one or more mountings 125 configured to hold the optical elements 110 firmly in place. Mountings 125 can comprise a single mounting, or a variety of different mountings to retain the optical elements 110 in place. Mountings can include washers, vises, press-fit mountings, retaining rings, lens holders, and the like. In many embodiments, mountings 125 have the same or similar coefficients of thermal expansion as the other parts of connector assembly 118. In many embodiments, mountings 125 are designed to have low fiction joints, actuator locks, and or the like. In some embodiments, optical elements are coupled to mountings 125 by glue or other similar materials.

In some embodiments, connector assembly 118 comprises an optical enclosure 130 that is configured to further facilitate alignment of fibers 102, 114 by way of optical elements 110. Similar to the connector assembly 118 and mountings 125, enclosure 130 comprise materials that have low or medium coefficients of thermal expansion, such as invar, kovar, carbon composites, silicon, zerodur, ultra-low expansion glass, pyroceram, quartz, graphite, aluminum-silicon alloys, stainless steel and the like.

In some embodiments, one or both ends of the enclosure 130 is threaded for mounting an optical element 110 to the end of the enclosure. In many embodiments, there is an air gap between the first optical element 110 and the second optical element 110.

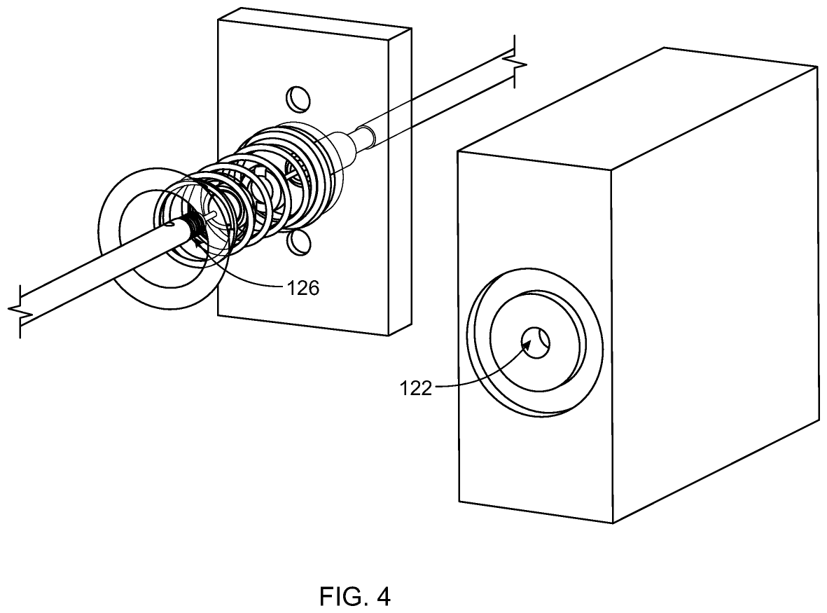

In some embodiments, and with reference to an embodiment illustrated in FIG. 4, one or more central bores 122 of the connector assembly 118 are meticulously manufactured to precise tolerances, enabling it to snugly accommodate optical fibers of standard sizes. The inner surfaces of the bores 122 are polished to a mirror-like finish, minimizing signal scattering and reflection losses. In many embodiments the connector assembly 118 comprises a material with a low coefficient of thermal expansion.

In some embodiments, fibers 102 and/or 114 comprise a silica-based glass fiber. In some embodiments, fibers 102 and/or 114 comprise a plastic such as polymethylmethacrylate (PMMA). In some embodiments, fibers 102 and/or 114 comprise a fluoride glass, a chalcogenide glass, a germanium-doped silica, plastics such as polyethylene or polycarbonate, photonic crystal fibers, sapphire and/or the like. In some embodiments, fibers 102 and/or 114 are configured as multimode optical fibers and/or single mode optical fibers. In some embodiments, the diameter and/or material of fiber 102 is the same as that of second fiber 114. In other embodiments, the diameter and/or material of fiber 102 differs from that of second fiber 114. In some embodiments, fibers 102 and/or 114 material that is difficult to bend (such as, for example, silica).

In some embodiments, the connector assembly 118 comprises alignment structures 126 within the bores 122. In some embodiments, the alignment structures 126 are designed to passively align the fibers 102, 114, ensuring that their cores are aligned along the same axis. Proper alignment helps minimize insertion losses and maximizing the transmission efficiency of optical signals. In some embodiments, the connector assembly 118 includes one or more clamping mechanisms that firmly hold the fibers 102, 114 in place within the bore 122. The clamping mechanisms can be easily engaged and disengaged, facilitating the installation and maintenance of optical connections. In some embodiments, the clamping mechanisms help keep the fibers 102, 114 in alignment under external factors like vibrations, thermal fluctuations, or mechanical stresses.

In some embodiments, probe 100 is configured to be vacuum compatible, such that a vacuum exists within the interior of the connector assembly 118. As such, probe 100 is configured with one or more vacuum sealing locations 106, 112. For example, in many embodiments, the vacuum of probe 100 provides thermal insulation and reduces heat loss or gain inside the connector assembly 118 and/or protects the internal components of the connector assembly 118 from oxidation, corrosion, or other forms of degradation that can occur when exposed to air or other gases. In many embodiments, the vacuum seal of probe 100 provides a barrier that prevents contaminants, such as moisture, dust, or other gases, from entering the interior of probe 100.

In many embodiments of vacuum sealed probes 100, various sealing mechanisms are used to maintain a vacuum within the connector assembly 118. For example, in many embodiments sealing mechanisms include, but are not limited to, o-rings, gaskets, welds, epoxies and other methods to maintain a hermetic seal. In some embodiments, an adjustable sealing mechanism is used to maintain the vacuum within probe 100.

In some embodiments, the spring-loaded mechanism may include a lens or mirror that moves to align with the collimated beams when the probe 100 is in use. When the optical components are aligned, light passes between the fibers efficiently. When the probe 100 is not in use, the components move away from each other, maintaining the vacuum seal.

In some embodiments, probe 100 uses one or more connectors that holds fibers 102, 114 and optical elements 110 in alignment. The connectors may be mounted on a mechanical stage within the connector assembly 118. The spring-loaded mechanism within connector assembly 118, when activated, moves the connectors into position to couple the light between the fibers 102, 114. When not in use, the connectors can be retracted to maintain the vacuum seal.

In other embodiments, micro-electro-mechanical systems (MEMS) mirrors can be integrated into the optical path within the connector assembly 118. These tiny mirrors can be controlled electronically or mechanically to direct the incoming light towards the outgoing fiber when needed. They can also be positioned away from the optical path to maintain the vacuum seal of connector assembly 118.

In other embodiments, probe 100 employs waveguides or optical waveguide couplers to guide light between fibers 102, 114. These waveguides can be part of the spring-loaded mechanism or be positioned in the connector assembly 118 in a way that allows for selective coupling when the probe is in use. In other embodiments, a rotating prism or diffraction grating may be employed within the connector assembly 118. When the probe 100 is activated, the prism or grating is positioned to direct light from the incoming fiber 102 to the outgoing fiber 114.

In some embodiments, the probe 100 is a spring loaded vacuum probe that has a flexible fiber bundle such that first fiber 102 and second fiber 114 are the same flexible fiber. In some embodiments, the probe 100 is a spring loaded vacuum probe that has a flexible fiber bundle such that first fiber 102 and second fiber 114 are coupled to one another via the flexible fiber bundle.

In some embodiments, the first fiber 102 is configured to pass through a converter unit to facilitate converting a first optical signal in the first fiber 102 that is used to drive the sensor element 116.

In some embodiments, an optical temperature sensor element 116 may also be coupled to the tip of the probe shaft 124, while being positioned and configured to be excited by light from the fiber 114 and to emit light back to the fiber 114. In other embodiments, the optical fiber 114 may interface with the optical temperature sensor element 116 by sending and/or receiving light through a gap or cavity between the optical fiber 114 and the optical temperature sensor element 116. Means for exciting the optical temperature sensor element 116 with light from the optical fiber 102 may include, for example, sending a pulse of light from a light source configured to emit light into the optical fiber 114 in the direction of the optical temperature sensor element 116. The light from the light source may travel through the optical fiber 114 and excite the optical temperature sensor element 116, which may consequently emit light back into the optical fiber 114. In some embodiments, light emitted by the excited optical temperature sensor element 116 may be measured by, for example, configuring a photodiode to receive light from the optical fiber 114 from the direction of the optical temperature sensor element 116. The intensity or decay time, for example, of the light emitted by the excited optical temperature sensor element 116 may be used to determine the temperature of the optical temperature sensor element 116.

In some embodiments, optical fiber 102 and/or 114 is configured within a probe shaft 124. In some embodiments, the probe shaft 124 may, for example, be realized by an elongated cylinder with a narrow diameter, such as 3-5 mm; however, other embodiments may utilize alternative geometries and diameters. The probe shaft 124 may also be constructed of a variety of materials. For example, the probe shaft 124 may include, or consist of, a rigid polymer, such as polyether ether ketone (PEEK), a ceramic, or a more pliable polymer. Rigid materials may allow the probe shaft 124 to maintain its structure and provide stability to the optical temperature sensing mechanism, while more pliable materials may enable the probe shaft 124 to deform and access hard-to-reach places.

In some embodiments, an optical temperature sensor element 116 is coupled to the end of fiber 114 and/or probe shaft 124. In some embodiments, the optical temperature sensor element 116 may, for example, be realized by a disk-shaped phosphorescent or fluorescent thermal sensor, which may contain a photoluminescent material or element; however, other optical temperature sensor elements and mechanisms known in the art having different geometries may be utilized without departing from the spirit or scope of this disclosure.

In some embodiments, a probe 100 uses a fluoroptic sensor 116 to measure temperature accurately. This sensor 116 contains a temperature-sensitive material or fluorophore that changes its fluorescence properties in response to temperature variations. The probe emits light into the material and detects changes in the returned fluorescent light to determine the temperature.

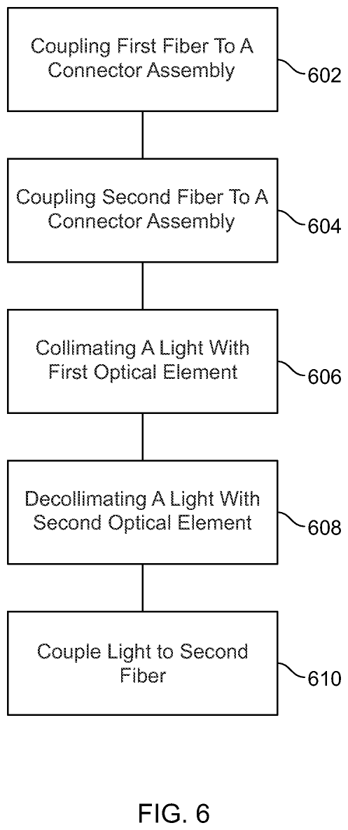

In other embodiments, and with reference to an embodiment in FIG. 6, a method of measuring the temperature of an element is provided. A first end of fiber 102 is coupled to a first end of connector assembly 118 (602). Similarly, a first end of fiber 114 is coupled to a second end of the connector assembly 118 (604). For example, fibers 104, 114 may be coupled to connector assembly 118 in a hermetically sealed manner, such that a vacuum is maintained within the connector assembly 118, as those manners have been described herein (i.e., using o-rings, epoxy and the like). Light from fiber 102 is then coupled from fiber 102 to a first optical element 110. For example, in some embodiments, the fiber is aligned directly to the surface of the first optical element 110, in other embodiments, there is a space between the fiber 102 and the optical element 110. In other embodiments, one or more alignment structures 126 are used to help couple light from the fiber 102 to the optical element 110. Next, the first optical element 110 collimates the light from the fiber 102 (606). The collimated beam of light then travels towards a second optical element 110, where it is decollimated (608). The decollimated light is then coupled into a first end of the second fiber 114 (610).

In some embodiments, methods of measuring the temperature of an element further comprise coupling a second end of the first fiber to a converter unit. In many embodiments, the connector assembly is vacuum sealed, such that collimating the light from the first fiber 102 using the first optical element 110 and decollimating the light into the second fiber 114 using the second optical element 110 occur in a vacuum. In various embodiments the method further comprises coupling a temperature sensor 116 to a second end of the second fiber 114.

In some embodiments, a thermally conductive plate may be coupled to the tip of the probe shaft 124 and be configured to be thermally exposed to the exterior environment in one direction. For example, a hole, or a thermally conductive material passing into the probe shaft 124 may provide such a means for thermally exposing the thermally conductive plate to the exterior environment, such as a test article. A surface of the thermally conductive plate not exposed to the exterior environment may also thermally interface with the optical temperature sensor element 116. Thus, the thermally conductive plate may thermally couple with an object in the exterior environment, such as a test article surface, as well as the optical temperature sensor element 116, potentially allowing for the transfer of thermal energy. In some embodiments, positioning the thermally conductive plate between a surface of the optical temperature sensor element 116 and the exterior environment may prevent light from the exterior environment from interacting with, and potentially exciting, the optical temperature sensor element 116 as well as the optical fiber 114, potentially enabling for an improvement in overall temperature measurement accuracy.

In some embodiments, the thermally conductive plate may, for example, be realized by material with high thermal conductivity, such as aluminum or other metal, shaped into a disk, rectangle, or other geometric shape. In some embodiments, the thermally conductive plate may, optionally, have a high emissivity coating, potentially applied using, for example, electroplating, painting, or physical vapor deposition (PVD). The high emissivity coating may improve thermal radiative coupling and, thereby, overall thermal coupling between the thermally conductive plate and a test article surface. Improvements in thermal coupling between the thermally conductive plate and test article surface may enhance the thermal coupling of the optical temperature sensor element 116 and the test article surface, potentially increasing temperature measurement accuracy.

In other embodiments, the thermally conductive plate may not be included in the optical temperature sensing mechanism. In such embodiments, the optical temperature sensor element 116 may be directly thermally exposed to the exterior environment in one direction, while the probe shaft 124 may surround and thermally isolate the optical temperature sensor element 116 from the exterior environment in the other directions. In some embodiments, the fiber 114 may directly interface with a first surface of the optical temperature sensor element 116, which may be seated in a recess of the tip of the probe shaft 124, and the thermally conductive plate may thermally interface with a second surface of the optical temperature sensor element 116.

In some embodiments, baffling may extend from the tip of the probe shaft 124 and surround the edges of the thermally conductive plate. Thus, the thermally conductive plate may be seated in the baffling extending from the tip of the probe shaft 124. The baffling may be cylindrical with a greater diameter than the probe shaft 124 and may extend along the surface of the thermally conductive plate to form a lip; however, in other variations the shape, angle, diameter, and length of the baffling may vary without departing from the spirit or scope of this disclosure. For example, in other embodiments, the baffling may have no lip over the thermally conductive plate or may extend from the tip of the probe shaft 124 in a flared or tapered configuration. In other variations, the baffling may extend from the tip of the probe shaft 124 and surround or encompass the entire optical temperature sensing mechanism. In yet other variations, the optical temperature sensing mechanism may be contained within the probe shaft 124, and the baffling may surround or encompass a hole in the probe shaft that exposes the optical temperature sensing mechanism to the exterior environment.

In some embodiments, the baffling may be constructed of a material with low thermal conductivity, such as a polymer or ceramic, which may provide a means for thermally isolating the optical temperature sensor element 116 and thermally conductive plate from the exterior environment in all directions not facing the test article surface. Additionally, the baffling may provide another means for thermally isolating the optical temperature sensor element 116 and thermally conductive plate by potentially inhibiting problematic turbulent convection and fluid flow during close non-contact and light contact temperature measurements of a test article surface. This inhibition of turbulent convection and fluid flow may potentially improve the thermal coupling of the optical temperature sensor element 116 and test article surface and, thereby, increase the accuracy of the temperature measurements.

In some embodiments, a removeable cap is provided atop sensor element 116. The cap protects sensor element 116 when probe is not in use.

In accordance with various embodiments, various means for thermally exposing one or more components of the optical temperature sensing mechanism to the exterior of the probe shaft, and thus a test article surface, may be implemented. For example, a hole in the probe shaft or a thermally conductive material passing into the probe shaft may thermally connect and expose the one or more components of the optical temperature sensing mechanism to the probe exterior. The thermal exposure of the one or more components of the optical temperature sensing mechanism to the exterior environment may allow for the optical temperature sensing mechanism to thermally couple to a test article surface.

While the one or more components of the optical temperature sensing mechanism may be thermally exposed to the exterior environment, various means for thermally isolating the one or more component of the optical temperature sensing mechanism from portions of the exterior environment may be implemented. For example, the one or more components of the optical temperature sensing mechanism may be housed within a low thermal conductivity material within the probe shaft. Additionally, or alternatively, low thermal conductivity baffling may extend from the probe shaft to create a more localized exterior environment to which the components of the optical temperature sensing mechanism may be thermally exposed. Such baffling may inhibit turbulent convection and fluid flow during close non-contact and light contact temperature measurements of a test article surface, potentially improving the thermal coupling of the optical temperature sensing mechanism and test article surface and, thereby, increasing the accuracy of the temperature measurements.

In some embodiments, low thermal conductivity baffling may extend from the probe shaft to form a cavity. The cavity may be coated with a reflective material, which may provide a means for redirecting thermal radiation from, for example, a test article surface towards the optical temperature sensing mechanism. Consequently, more thermal radiation emitted by a test article surface may potentially be absorbed by the optical temperature sensing mechanism, rather than being absorbed by the cavity walls. Such a redirection of thermal radiation may improve the thermal coupling of the optical temperature sensing mechanism and the test article surface allowing for an increase in temperature measurement accuracy, particularly in low pressure environments.

In some embodiments, the optical temperature sensing mechanism may be coupled to the tip of the probe shaft with a baffling extending from the tip of the probe shaft. Some embodiments may have an optical temperature sensing mechanism and baffling that is at an angle with the probe shaft, such as 30°, 45°, or 90°. The tip of the optical fiber may be angled and polished to interface with the angled optical temperature sensing mechanism. Angling the optical temperature sensing mechanism and baffling may enable for easier access to test article surfaces in certain applications.

In some embodiments, the optical temperature sensing mechanism may comprise an optical temperature sensor element coupled to the tip of the probe shaft. The optical temperature sensor element may be realized, for example, by a phosphorescent or fluorescent thermal sensor; however, other optical temperature sensor elements and mechanisms known in the art may be utilized. The optical temperature sensor element may be positioned and configured to be excited by light from the optical fiber and to emit light back to the optical fiber that is indicative of a temperature that the sensor element is exposed to. Means for exciting the optical temperature sensor element with light from the optical fiber may include, for example, sending a pulse of light from a light source configured to emit light into the optical fiber in the direction of the optical temperature sensor element. The light from the light source may travel through the optical fiber and excite the optical temperature sensor element, which may consequently emit light back into the optical fiber. Means for measuring the light emitted by the excited optical temperature sensor element may include, for example, configuring a photodiode to receive light from the optical fiber from the direction of the optical temperature sensor element. The intensity or decay time, for example, of the light emitted by the excited optical temperature sensor element may be used to determine the temperature of the optical temperature sensor element.

In some embodiments, the optical temperature sensing mechanism may further comprise a thermally conductive plate coupled to the tip of the probe shaft configured to interface with the optical temperature sensor element. The thermally conductive plate may be positioned to prevent light from the exterior environment from interacting with, and potentially exciting, the optical temperature sensor element as well as the optical fiber. The potential reduction in exterior light interference with the optical temperature sensing mechanism may enable for an improvement in overall temperature measurement accuracy.

In some embodiments, the thermally conductive plate may additionally be configured to be thermally exposed to both the exterior environment and the optical temperature sensor element, which enables for the thermally conductive plate to thermally couple with a test article surface as well as the optical temperature sensor element. In some embodiments, the thermally conductive plate may be positioned between the test article surface and the optical temperature sensor element so that the thermally conductive plate may absorb thermal energy from the test article surface and transfer that energy to the optical temperature sensor element. Larger thermally conductive plates may enable for a faster transfer of thermal energy, reducing the time needed to take a temperature measurement; however, larger thermally conductive plates may have a larger sample area on the test article surface.

In some embodiments, the thermally conductive plate may have a high emissivity coating, which may improve thermal radiative coupling and, thereby, overall thermal coupling between the thermally conductive plate and the exterior environment, such as a test article surface. Improvements in thermal coupling between the thermally conductive plate and test article surface may enhance the thermal coupling of the optical temperature sensor element and the test article surface, potentially increasing temperature measurement accuracy.

In some embodiments, baffling may extend from the tip of the probe shaft and surround the edges of the thermally conductive plate. Thus, the thermally conductive plate may be seated in the baffling extending from the tip of the probe shaft. In other embodiments, the baffling may extend from the tip of the probe shaft and surround or encompass the entire optical temperature sensing mechanism. In other embodiments, the optical temperature sensing mechanism may be contained within the probe shaft, and the baffling may surround or encompass a hole in the probe shaft that exposes the optical temperature sensing mechanism to the exterior environment.

In some embodiments, the baffling may extend to form a cavity adjacent to the thermally conductive plate. Optionally, this cavity may be coated with a reflective material, which may provide a means for redirecting thermal radiation from, for example, a test article surface towards the thermally conductive plate. Consequently, more thermal radiation emitted by a test article surface may potentially be absorbed by the thermally conductive plate, rather than being absorbed by the cavity walls. Such a redirection of thermal radiation may improve the thermal coupling of the optical temperature sensing mechanism and the test article surface allowing for an increase in temperature measurement accuracy, particularly in low pressure environments.

In some embodiments, the optical temperature sensor element, thermally conductive plate, and baffling may be at an angle with the probe shaft, such as 30°, 45°, or 90°, and the tip of the optical fiber may be angled and polished to interface with the optical temperature sensor element. Angling the optical temperature sensor element, thermally conductive plate, and baffling may enable for easier access to test article surfaces in certain applications.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A fiber optic temperature probe comprising:
a first fiber coupled to a connector assembly;
a second fiber coupled to the connector assembly, wherein the connector assembly includes a first optical element to collimate light from the first fiber and a second optical element to decollimate light into a first end of a second fiber; and
a temperature sensor coupled to a second end of the second fiber.

2. The fiber optic temperature probe of claim 1, wherein the first optical element and the second optical element are located within a spring-loaded vacuum.

3. The fiber optic temperature probe of claim 1, wherein the first fiber is coupled to a converter unit prior to coupling the first fiber to the connector assembly.

4. The fiber optic temperature probe of claim 1, wherein the first fiber and the second fiber comprise materials difficult to bend.

5. The fiber optic temperature probe of claim 1, wherein the first optical element comprises one of a refractive or reflective optical devices such as lenses, ball lenses, lens arrays, mirrors, mirror arrays with various surface profiles such as spherical, aspherical, diffractive, and meta-surfaces.

6. The fiber optic temperature probe of claim 5, wherein the second optical element comprises one of a refractive or reflective optical devices such as lenses, ball lenses, lens arrays, mirrors, mirror arrays with various surface profiles such as spherical, aspherical, diffractive, and meta-surfaces.

7. The fiber optic temperature probe of claim 6, wherein the first optical element and the second optical element each comprises an optical material such as Gradient Refractive Index (GRIN) or meta-material.

8. The fiber optic temperature probe of claim 1, wherein the temperature sensor is coupled to a probe shaft surrounding the second fiber.

9. The fiber optic temperature probe of claim 1, wherein the temperature sensor comprises one of a phosphorescent or a fluorescent material.

10. The fiber optic temperature probe of claim 8, further comprising a thermally conductive plate coupled to a tip of the probe shaft and configured to be thermally exposed to an exterior environment in a desired direction.

11. The fiber optic temperature probe of claim 10, wherein a surface of the thermally conductive plate not exposed to the exterior environment is configured to thermally interface with the temperature sensor.

12. A fiber optic temperature probe comprising:
a first fiber coupled to a connector assembly;
a second fiber coupled to the connector assembly, wherein the connector assembly includes a first ball lens to collimate light from the first fiber and a second ball lens to decollimate light into a first end of a second fiber; and
a temperature sensor coupled to a probe shaft surrounding the second fiber.

13. The fiber optic temperature probe of claim 12, wherein the first ball lens and the second ball lens are located within a spring-loaded vacuum.

14. The fiber optic temperature probe of claim 12, wherein the first fiber is coupled to a converter unit prior to coupling the first fiber to the connector assembly.

15. The fiber optic temperature probe of claim 12, wherein the first fiber and the second fiber comprise silica.

16. The fiber optic temperature probe of claim 12, wherein the temperature sensor comprises one of a phosphorescent or a fluorescent material.

17. The fiber optic temperature probe of claim 12, further comprising a thermally conductive plate coupled to a tip of the probe shaft and configured to be thermally exposed to an exterior environment in one direction.

18. The fiber optic temperature probe of claim 17, wherein a surface of the thermally conductive plate not exposed to the exterior environment is configured to thermally interface with the temperature sensor.

19. A method of measuring a temperature of an element, comprising:
coupling a first end of a first fiber to a connector assembly;
coupling a first end of a second fiber to a connector assembly;
collimating a light from the first fiber using a first optical element;
decollimating the light from the first fiber using a second optical element; and
coupling the light from the first fiber into the second fiber using the second optical element.

20. The method of claim 19, further comprising coupling a second end of the first fiber to a converter unit.

21. The method of claim 19, wherein collimating the light from the first fiber using the first optical element and decollimating the light from the first fiber using the second optical element occur in a vacuum.

22. The method of claim 19, wherein coupling the first end of the first fiber to the connector assembly comprises coupling a first silica fiber to the connector assembly, and wherein coupling the first end of the second fiber to the connector assembly comprises coupling a second silica fiber to the connector assembly.

23. The method of claim 19, further comprising coupling a temperature sensor to a second end of the second fiber.
